(19) United States
(12) Patent Application Publication
(10) Pub. No.: US 2026/0276038 A1
(43) Pub. Date: Sep. 17, 2026

(54) SLIDING MEMBER

(71) Applicant: DAIDO METAL CO., LTD., Nagoya (JP)

(72) Inventor: Minami YAMADA, Inuyama-Shi (JP)

(21) Appl. No.: 19/560,543

(22) Filed: Mar. 9, 2026

(30) Foreign Application Priority Data
Mar. 17, 2025 (JP) 2025-042530

(51) Int. Cl. F16C 33/12; C22C 9/02

(52) U.S. Cl. CPC F16C 33/121; C22C 9/02; F16C 2202/04; F16C 2204/12

(57) ABSTRACT

A sliding member includes a back metal portion; and a sliding alloy portion provided on one surface of the back metal portion and having a sliding surface opposite to the back metal portion. The sliding alloy portion includes a matrix consisting of a Cu-based alloy containing 5 to 15% by mass of Sn, with the remainder including an unavoidable impurity; 0.5 to 3% by mass of graphite particles; and additive particles formed of 0.1 to 20% by mass of one selected from Co, Mo, Cr, and W, or an alloy thereof, and having a hardness of 200 HV to 500 HV. The graphite particles satisfy S1:S2=1:1.5 to 2.5, wherein S1 represents an area of a first surface in a thickness direction perpendicular to the sliding surface, and S2 represents an area of a second surface parallel to the sliding surface perpendicular to the first surface.

### CROSS-REFERENCE TO RELATED APPLICATION(S)

This US Non-Provisional Patent Application relies on and claims priority to Japanese Patent Application No. 2025-042530, filed on Mar. 17, 2025, the entire contents of which are incorporated herein by reference.

### FIELD OF THE INVENTION

The present embodiment relates to a sliding member.

### DESCRIPTION OF THE RELATED ART

Sliding members have been required to avoid the use of Pb in consideration of environmental impact. Thus, Cu-based sliding members contain Bi or Ni as an additive element (see Japanese Patent Laid-Open Nos. 2018-54097 and 2003-269456). In a Cu-based sliding member containing Bi as in Japanese Patent Laid-Open No. 2018-54097, the material tends to be brittle. The Cu-based sliding member containing Bi exhibits sufficient performance under a conventional peripheral speed condition of about 0.5 to 2.0 m/s; however, it lacks mechanical properties such as strength, for example, under a peripheral speed condition higher than the conventional peripheral speed. Moreover, a Cu-based sliding member containing Ni as in Japanese Patent Laid-Open No. 2003-269456 tends to have low conformability. Therefore, the Cu-based sliding member containing Ni lacks seizure resistance under a high peripheral speed condition. Furthermore, a Cu-based sliding member containing hard particles such as a metal carbide, for example, tends to easily damage a counter material. Therefore, while the hard particles are expected to be sufficiently effective under a low peripheral speed condition, the hard particles cause an increase in friction and the like originating from damage generated on the counter material under a high peripheral speed condition. As a result, the Cu-based sliding member containing hard particles lacks seizure resistance under a high peripheral speed condition.

Accordingly, an object of the present invention is to provide a Cu-based sliding member that ensures mechanical properties and conformability and has high seizure resistance and wear resistance, even under a high peripheral speed condition.

### SUMMARY OF THE INVENTION

In order to achieve the above-mentioned object, a sliding member of the present embodiment includes a back metal portion; and a sliding alloy portion provided on one surface of the back metal portion and having a sliding surface opposite to the back metal portion. The sliding alloy portion includes a matrix consisting of a Cu-based alloy containing 5 to 15% by mass of Sn, with the remainder including an unavoidable impurity; 0.5 to 3% by mass of graphite particles; and additive particles formed of 0.1 to 20% by mass of one selected from Co, Mo, Cr, and W, or an alloy thereof, and having a hardness of 200 HV to 500 HV. The graphite particles satisfy S1:S2=1:1.5 to 2.5, wherein S1 represents an area of a first surface, which is a cross section in a thickness direction perpendicular to the sliding surface, and S2 represents an area of a second surface, which is a cross section parallel to the sliding surface perpendicular to the first surface.

As described above, the sliding member of the present embodiment sets the content of Sn in the Cu-based alloy. In this manner, the sliding member of the present embodiment avoids the formation of an intermetallic compound at the grain boundaries of crystals contained in the matrix while maintaining the mechanical strength of the matrix. As a result, the sliding member of the present embodiment ensures appropriate toughness of the matrix and ensures mechanical properties and conformability. Furthermore, in the sliding member of the present embodiment, the area S2 is larger than the area S1 in the graphite particles. That is, in the sliding member of the present embodiment, the graphite particles are contained in a flat state along the sliding surface, in the matrix of the sliding alloy portion. In this manner, the coefficient of friction can be reduced by the lubricating action of the graphite particles along the sliding surface, resulting in improved seizure resistance. Furthermore, in the sliding member of the present embodiment, the additive particles contained in the sliding alloy portion have a hardness of 200 HV to 500 HV. Therefore, in the present embodiment, the additive particles contained in the sliding alloy portion have low aggressiveness to the counter material with which the sliding member slides. As a result, the sliding member of the present embodiment is less likely to damage the counter material, and exhibits less increase in friction, less adhesion to the counter member, and the like originating from the damage. Therefore, the mechanical properties and conformability can be ensured, and the seizure resistance as well as wear resistance can be improved, even under a high peripheral speed condition.

### BRIEF DESCRIPTION OF THE DRAWINGS

FIG. 1 is a schematic diagram showing a cross section of a sliding member according to one embodiment;

FIG. 2 is a schematic diagram corresponding to the first surface with the enlarged portion II in FIG. 1;

FIG. 3 is a schematic diagram corresponding to the second surface along the line III-III in FIG. 2;

FIG. 4 is a table showing an outline of the conditions for a wear resistance test of the sliding member according to one embodiment;

FIG. 5 is a schematic diagram showing a specimen for use in the wear resistance test of the sliding member according to one embodiment;

FIG. 6 is a schematic diagram showing a specimen for use in testing the mechanical strength of the sliding member according to one embodiment;

FIG. 7 is a table showing an outline of the conditions for a seizure resistance test of the sliding member according to one embodiment;

FIG. 8 is a table showing an outline of the results of examples and comparative examples of the sliding member according to one embodiment;

FIG. 9 is a table showing an outline of the results of examples and comparative examples and comparative examples of the sliding member according to one embodiment; and

FIG. 10 is a table showing an outline of the results of examples of the sliding member according to one embodiment.

### DETAILED DESCRIPTION OF EMBODIMENT(S) OF THE INVENTION

A sliding member according to the present embodiment will be described below based on the drawings. As used herein, “X to Y” representing a numerical range includes the values of X and Y at both endpoints.

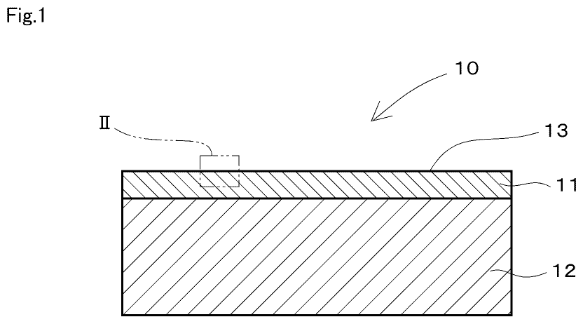

As shown in FIG. 1, a sliding member 10 of the present embodiment includes a sliding alloy portion 11 and a back metal portion 12. The sliding alloy portion 11 is provided on one surface of the back metal portion 12. The sliding alloy portion 11 has a sliding surface 13 opposite to the back metal portion 12. The sliding surface 13 of the sliding member 10 slides against a counter material (not shown). The sliding member 10 of the present embodiment is applicable to, for example, piston shoes or valve plates for high-pressure pumps, and is used in a flat-plate shape. The sliding member 10 has a plate thickness of about several millimeters to several tens of millimeters, and the sliding alloy portion 11 is used in a thickness of several millimeters or less.

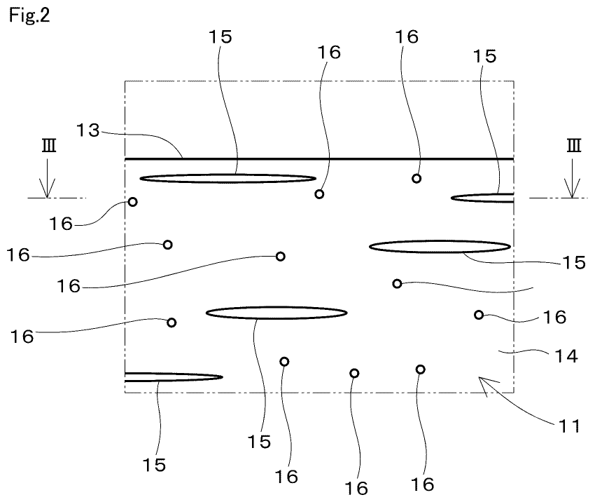

As shown in FIG. 2, the sliding alloy portion 11 includes a matrix 14, graphite particles 15, and additive particles 16. The matrix 14 is formed of a Cu-based alloy containing 5 to 15% by mass of Sn relative to the total of the sliding alloy portion 11, with the remainder including an unavoidable impurity. The content of Sn in the sliding alloy portion 11 is preferably 12% by mass or less. If the content of Sn in the sliding alloy portion 11 is less than 5% by mass, the effect of adding Sn to the matrix 14 is insufficient, and the strength of the matrix 14 decreases. As a result, the sliding alloy portion 11 has poor load resistance during sliding. On the other hand, if the content of Sn in the sliding alloy portion 11 is above 15% by mass, an intermetallic compound is likely to form at the grain boundaries of crystals contained in the matrix 14. The intermetallic compound formed at the grain boundaries of crystals causes the matrix 14 to be brittle and the toughness of the matrix 14 to decrease. Thus, the content of Sn in the sliding alloy portion 11 is preferably set to 15% by mass or less, and is more preferably set to 12% by mass or less.

The graphite particles 15 and the additive particles 16 are dispersed in the matrix 14 of the sliding alloy portion 11. The sliding alloy portion 11 contains 0.5 to 3% by mass of the graphite particles 15. The sliding alloy portion 11 more preferably contains 1 to 2% by mass of the graphite particles 15. The graphite particles 15 are particulate. As used herein, the term “particulate graphite particles 15” in the present embodiment includes a flat flake shape. That is, the “particulate graphite particles 15” includes not only a three-dimensional shape having lengths in the three axial directions in three dimensions, but also a flake shape whose length in one axial direction in three dimensions is sufficiently smaller than the lengths in the other two axial directions.

The sliding alloy portion contains 0.1 to 20% by mass of the additive particles 16. The sliding alloy portion more preferably contains 0.1 to 10% by mass of the additive particles 16. The additive particles 16 are in the form of fine particles. The additive particles 16 are formed of one selected from Co, Mo, Cr, and W, or an alloy containing any of these components as a main component. That is, the additive particles 16 are formed of a single metal of Co, Mo, Cr, or W, or a compound containing Co, Mo, Cr, or W as a first element. The additive particles 16 have a hardness of 200 HV to 500 HV. The additive particles 16 formed of these metals or alloys do not form an intermetallic compound with the Cu—Sn alloy during processing of the sliding alloy portion 11. Therefore, a decrease in the hardness of the sliding alloy portion 11 can be inhibited. Moreover, the aggressiveness to the counter material is reduced by setting the hardness of the additive particles 16 to 200 HV to 500 HV. As a result, the sliding member 10 is less likely to damage the counter material, and exhibits less increase in friction, less adhesion to the counter member, and the like originating from the damage. In particular, the metal or compound selected as the material of the additive particles 16 is a component different from the main component Cu—Sn of the sliding alloy portion 11 and from the components of the counter material for sliding. Therefore, the additive particles 16 also exhibit less transfer and adhesion to the counter material.

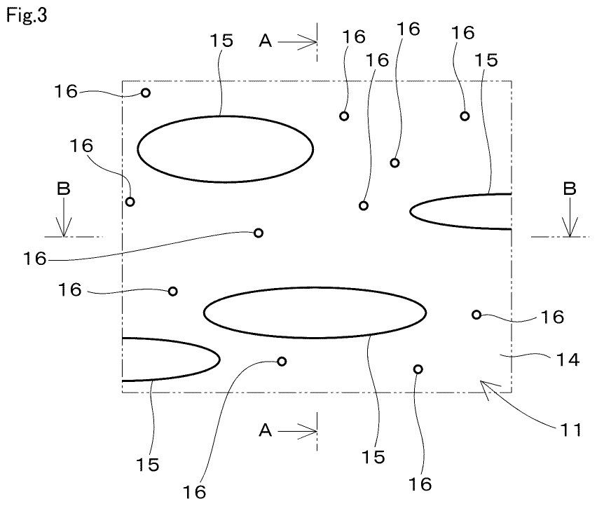

The graphite particles 15 are dispersed in the matrix 14 in the sliding alloy portion 11. Here, a cross section of the sliding alloy portion 11 perpendicular to the sliding surface 13 is represented as a first surface, and a cross section of the sliding alloy portion 11 perpendicular to the first surface is represented as a second surface. That is, the cross section in the thickness direction obtained by cutting the sliding alloy portion 11 perpendicularly to the sliding surface 13 as shown in FIG. 2 is represented as the first surface, and the cross section parallel to the sliding surface 13 obtained by cutting the sliding alloy portion 11 perpendicularly to the first surface as shown in FIG. 3 is represented as the second surface. The graphite particles 15, which are flake-shaped particles, have a flat shape. In the present embodiment, the graphite particles 15 satisfy the relationship S1:S2=1:1.5 to 2.5 between the area S1 of the cross section in the first surface and the area S2 of the cross section in the second surface.

That is, in the present embodiment, each graphite particle 15 contained in the sliding alloy portion 11 has a thin and small cross section in the thickness direction as shown in FIG. 2, while having a large cross section in the direction along the sliding surface 13 as shown in FIG. 3. In other words, the sliding alloy portion 11 of the present embodiment contains the thin flake-shaped graphite particles 15 in the form of layers substantially parallel to the sliding surface 13. Therefore, each graphite particle 15 contained in the sliding alloy portion 11 has a relatively small cross section in the first surface as shown in FIG. 2, while having a relatively large cross section in the second surface as shown in FIG. 3. The ratio between the areas S1 and S2 is calculated using a sum of the cross-sectional areas of the graphite particles 15 in an arbitrary first surface and a sum of the cross-sectional areas of the graphite particles 15 in an arbitrary second surface, in the same sliding member 10. It should be noted that the first surface may be set in an arbitrary position as indicated by the cross section A-A or the cross section B-B in FIG. 3, for example, as long as the first surface is a cross section perpendicular to the second surface. That is, the second surface shown in FIG. 3 is exemplary, and the longitudinal direction of each graphite particle 15 as viewed from the sliding surface 13 may be an arbitrary direction, as long as the graphite particles 15 contained in the sliding alloy portion 11 are in a position substantially parallel to the sliding surface 13.

If S1:S2 is less than 1:1.5, the amount of the graphite particles 15 that contribute to reducing the friction with the counter material on the sliding surface 13 is insufficient. In other words, when S1:S2 is less than 1:1.5, the area of the graphite particles 15 exposed on the sliding surface 13 is relatively small. Therefore, the contribution of the graphite particles 15 as a solid lubricant decreases, and the seizure resistance decreases. Furthermore, if S1:S2 is above 1:2.5, the graphite particles 15 have an excessively small thickness, which reduces the bonding strength with the matrix 14, and causes premature wear even though the graphite particles 15 are exposed on the sliding surface 13. That is, when the thickness of the graphite particles 15 is excessively small, the area of the graphite particles 15 in the second surface parallel to the sliding surface 13 is relatively large. Therefore, the mutual bonding strength of the matrix 14 sandwiching each graphite particle 15 in the thickness direction relatively decreases, and the graphite particles 15 are likely to fall off from the matrix 14. As a result, the contribution of the graphite particles 15 as a solid lubricant decreases, and the wear resistance decreases. Therefore, the ratio between the areas S1 and S2 is set at S1:S2=1:1.5 to 2.5.

As described above, the sliding alloy portion 11 contains the graphite particles 15. The graphite particles 15 are exposed on the sliding surface 13 in the sliding alloy portion 11. An area ratio R of the graphite particles 15 occupying the sliding surface 13 is 2 to 20%. An arbitrary observation region is set on the sliding surface 13, and when the area of the observation region is represented as a region area A and the area of the graphite particles 15 included in the observation region is represented as a graphite area B, the area ratio R is calculated as R=B/A×100. The area ratio R indicates that the larger the area ratio R, the larger the area of the graphite particles 15 exposed on the sliding surface 13. If the area ratio R is excessively large and the area of the graphite particles 15 occupying the sliding surface 13 increases, the ratio of the matrix 14 of the sliding alloy portion 11 occupying the sliding surface 13 decreases. Therefore, the sliding alloy portion 11 cause a decrease in wear resistance and mechanical strength.

On the other hand, when the area ratio R is excessively small and the area of the graphite particles 15 shown on the sliding surface 13 is small, the ratio of the graphite particles 15 occupying the sliding surface 13 decreases. Therefore, the contribution of the graphite particles 15 as a solid lubricant decreases, and the seizure resistance decreases. The area ratio R of the graphite particles 15 varies depending on the content of the graphite particles 15 in the sliding alloy portion 11. That is, the area ratio R correlates with the content of the graphite particles 15. When the content of the graphite particles 15 is 0.5% by mass, which is the lower limit in the present embodiment, the area ratio R is about 2%. On the other hand, when the content of the graphite particles 15 is 3% by mass, which is the upper limit in the present embodiment, the area ratio R is about 20%. Therefore, the area ratio R is preferably set to 2 to 20%, and is more preferably set to 5 to 11%.

A method for manufacturing the sliding member 10 of the present embodiment will be described next.

A powder of a Cu—Sn alloy as the material of the matrix 14, the graphite particles 15, and a powder of the additive particles 16 are mixed in a blender. An irregular-shaped powder, rather than a spherical powder, is preferably used as the powder of the Cu—Sn alloy. On the other hand, a substantially spherical powder is used as the additive particles 16. Flake-shaped particles with an average particle diameter of 50 to 150 μm are used as the graphite particles 15. The particle diameter of the graphite particles 15 is measured by a sieving method, for example. In the present embodiment, the graphite particles 15 are mixed in advance with the powder of the Cu—Sn alloy and the additive particles 16 in a blender, so that they are uniformly mixed without uneven distribution. The mixed powder is spread on a steel plate (not shown) that serves as the back metal portion 12. In this case, the steel plate is preferably Cu-plated, for example, in order to ensure adhesiveness to the Cu—Sn alloy that serves as the sliding alloy portion 11. The powder spread on the steel plate is subjected to primary sintering together with the steel plate in a furnace in a reducing atmosphere. In this manner, the steel plate serving as the back metal portion 12 and the layer serving as the sliding alloy portion 11 are formed as an integral primary product. In this case, the powders serving as the raw materials have been mixed in advance as described above, so that the graphite particles 15 and the additive particles 16 are dispersed in the matrix 14 of the Cu—Sn alloy without uneven distribution. The primary product produced in the primary sintering is rolled. This rolling allows the posture of the graphite particles 15 contained in the layer serving as the sliding alloy portion 11 to be controlled inside the matrix 14, and allows the S1:S2 ratio to be controlled as described in the present embodiment. The primary product that has been rolled is subjected to secondary sintering. This secondary sintering imparts conformability to the sliding alloy portion 11.

Examples of the present embodiment will be described next.

### Calculation of S1 and S2

The area S1 in the first surface and the area S2 in the second surface were both calculated based on an image of a polished cross section taken with a digital microscope. Specifically, the matrix 14 and the graphite particles 15 were extracted from the image taken. Then, image analysis was used to calculate the sum of the areas S1 of the graphite particles 15 in the first surface and the sum of the areas S2 of the graphite particles 15 in the second surface.

### Evaluation of Wear Resistance

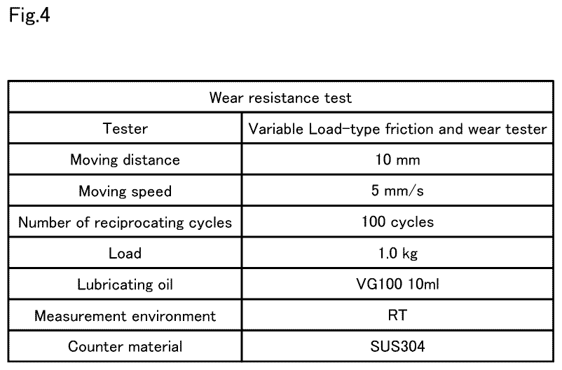

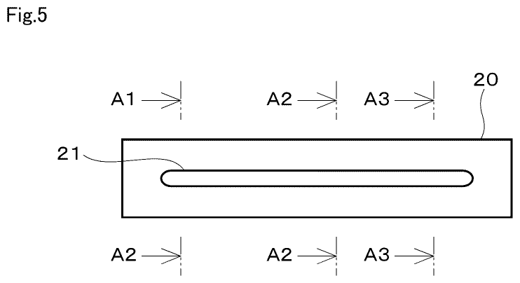

The wear resistance was evaluated under the conditions shown in FIG. 4, using a variable load-type friction and wear tester (HEIDON). SUS304 was used as the counter material. As a result of this test of wear resistance, as shown in FIG. 5, a sliding mark 21 caused by contact with the counter material (not shown) was formed on a specimen 20. The amount of wear was measured based on the cross-sectional areas of the sliding mark 21 in cross sections perpendicular to the sliding mark 21. The amount of wear was determined by measuring the cross-sectional areas of the sliding mark 21 in the cross section A1-A1, the cross section A2-A2, and the cross section A3-A3 shown in FIG. 5, for example, and using the average of these cross-sectional areas. The amount of wear was measured at three arbitrary positions with respect to one sliding mark 21.

### Evaluation of Mechanical Strength

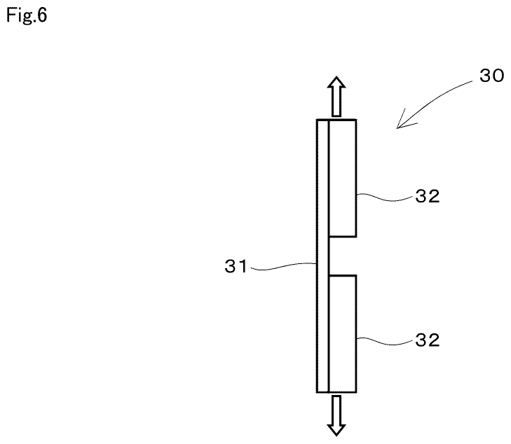

The mechanical strength was evaluated using tensile strength. As shown in FIG. 6, in the examples and comparative examples, tensile strength was measured using a specimen 30. The specimen 30 had a shape formed by removing a portion of the back metal portion 32 from the integral member of the sliding alloy portion 31 and the back metal portion 32 to leave the sliding alloy portion 31 on a portion of the back metal portion 32. A tensile load was applied to both ends of the specimen 30, and the tensile strength was measured based on the maximum tensile load at the time of breakage of the sliding alloy portion 31.

### Evaluation of Seizure Resistance

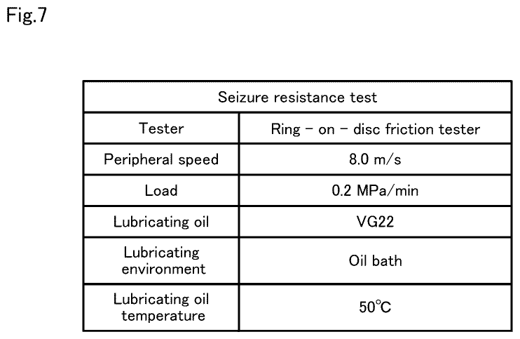

The seizure resistance was evaluated using a ring-on-disc friction tester under the conditions as shown in FIG. 7. Specifically, a load was applied under the conditions shown in FIG. 7, the maximum surface pressure at which seizure did not occur was measured, and the seizure resistance was evaluated based on the maximum surface pressure. This evaluation of seizure resistance was performed at a peripheral speed of 8.0 m/s, which is higher than the conventional peripheral speed.

### Evaluation Results

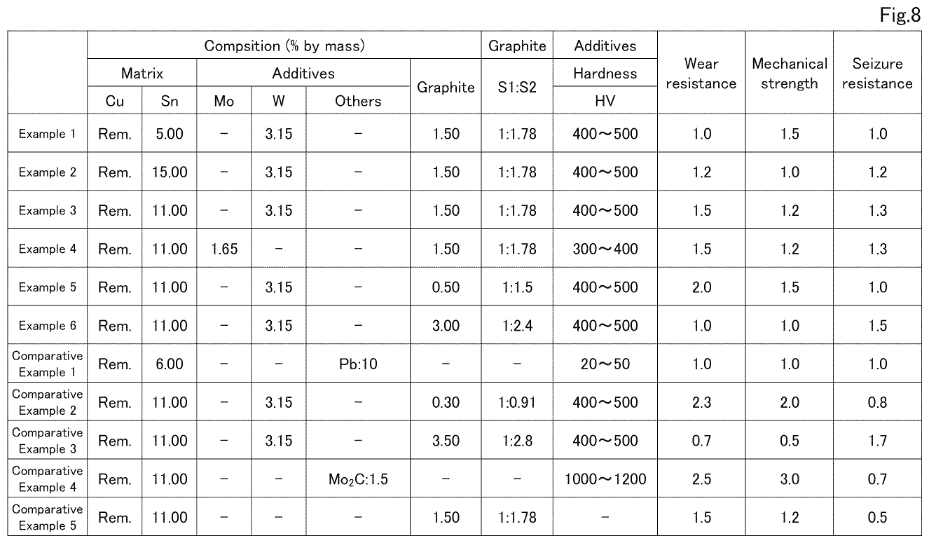

The evaluation results of the examples and comparative examples are shown in FIGS. 8 to 10.

Each of the examples and comparative examples was evaluated based on “Comparative Example 1”, which is a conventional product containing Pb in the sliding alloy portion 11. Specifically, “Mechanical strength”, “Seizure resistance”, and “Wear resistance” in “Comparative Example 1” were each taken as “1”, and each of the examples and comparative examples was evaluated based on the extent of improvement or decrease relative to this “reference example”. For example, when “Mechanical strength” in “Comparative Example 1” is “150 MPa”, “Mechanical strength” of “1.1” of the example or comparative example indicates “165 MPa”. The same applies to the evaluation of “Seizure resistance” and “Wear resistance”. It should be noted that “Mechanical strength” of “150 MPa” in “Comparative example 1” mentioned above is exemplary.

In Examples 1 to 3 shown in FIG. 8, the effect of the content of Sn in the matrix 14 in the sliding alloy portion 11 was evaluated. In Examples 1 to 3, the ratio of S1 to S2 in the graphite particles was S1:S2=1:1.78. Moreover, in all of Examples 1 to 3, 3.15% by mass of W was contained as the additive particles 16. As a result, the hardness of the particles derived from the additive particles 16 contained in the sliding alloy portion 11 of Examples 1 to 3 was 400 HV to 500 HV. In all of Examples 1 to 3, the wear resistance, mechanical strength, and seizure resistance were maintained or improved as compared to those in Comparative Example 1. In particular, in Example 3 in which the content of Sn was 11% by mass, all of the wear resistance, mechanical strength, and seizure resistance were significantly improved.

In Examples 3 to 6 and Comparative Examples 2 to 5, the effect of the content of the graphite particles 15 in the matrix 14 in the sliding alloy portion 11 was evaluated. In Example 4, Mo was blended as the additive particles 16, instead of W in Example 3. The content of the graphite particles 15 was at the lower limit in Example 5, whereas the content of the graphite particles 15 was at the upper limit in Example 6. The content of the graphite particles 15 was below the lower limit in Comparative Example 2, whereas the content of the graphite particles 15 was above the upper limit in Comparative Example 3. Moreover, Comparative Example 4 is an example containing the additive particles 16 instead of the graphite particles 15, and Comparative Example 5 is an example containing the graphite particles 15 instead of the additive particles 16. The foregoing shows that the wear resistance, mechanical strength, and seizure resistance of the sliding member 10 are improved by appropriately blending the additive particles 16 while adjusting the S1:S2 and the content of the graphite particles 15 in the matrix 14 in the sliding alloy portion 11.

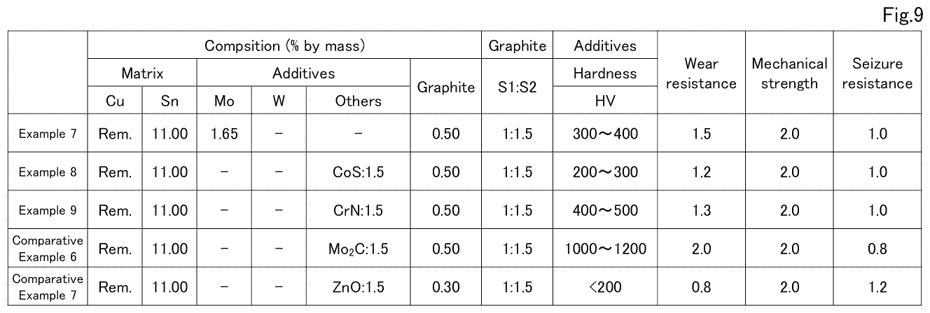

In Examples 7 to 9, and Comparative Examples 6 and 7 shown in FIG. 9, the effect of the material of the additive particles 16 contained in the matrix 14 in the sliding alloy portion 11 was evaluated. In Examples 7 to 9, and Comparative Examples 6 and 7, the content of Sn in the matrix 14 was 11.00% by mass, and the content of the graphite particles 15 was 0.50% by mass. Mo was contained as the additive particles 16 in Example 7; CoS, which is a compound of Co, was contained as the additive particles 16 in Example 8; and CrN, which is a compound of Cr, was contained as the additive particles 16 in Example 9. In all of these examples, the hardness of the additive particles 16 was 200 HV to 500 HV. On the other hand, in Comparative Example 6, Mo₂C, which is a compound of Mo, was contained as the additive particles 16; however, the hardness was 1000 HV to 1200 HV. Furthermore, in Comparative Example 7, ZnO was contained as the additive particles 16, and the hardness was less than 200 HV. The foregoing shows that the wear resistance, mechanical strength, and seizure resistance of the sliding member 10 are improved by appropriately selecting the material of the additive particles 16 contained in the matrix 14 in the sliding alloy portion 11 and appropriately setting the hardness of the additive particles 16.

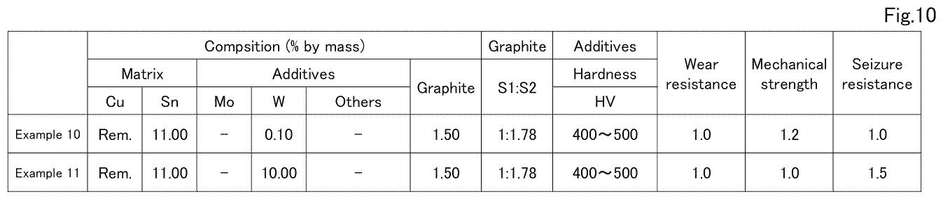

In Examples 10 and 11 shown in FIG. 10, the effect of the content of the additive particles 16 in the matrix 14 in the sliding alloy portion 11 was evaluated. In Example 10, the content of Sn in the matrix 14 was 11.00% by mass, and the content of the graphite particles 15 was 1.50% by mass. Moreover, 0.10% by mass of W was contained as the additive particles 16 in Example 10, and 10.00% by mass of W was contained as the additive particles 16 in Example 11. The foregoing shows that the additive particles 16 do not adversely affect the improvement of wear resistance, mechanical strength, and seizure resistance as long as the content of the additive particles 16 in the sliding alloy portion 11 is in the range of 0.1 to 20% by mass. In particular, considering the ease of manufacturing, the content of the additive particles 16 in the sliding alloy portion 11 is preferably 10% by mass or less.

As described above, the sliding member 10 of the present embodiment sets the content of Sn in the Cu-based alloy forming the sliding alloy portion 11. In this manner, the sliding alloy portion 11 avoids the formation of an intermetallic compound at the grain boundaries of crystals contained in the matrix 14 while maintaining the mechanical strength of the matrix 14. As a result, the sliding member 10 ensures appropriate toughness of the matrix 14, and ensures mechanical properties and conformability.

Furthermore, in the sliding member 10 of the present embodiment, the area S2 is larger than the area S1 in the graphite particles 15. That is, in the sliding member 10, the graphite particles 15 are contained in a flat state along the sliding surface 13, in the matrix 14 of the sliding alloy portion 11. In this manner, the coefficient of friction can be reduced by the lubricating action of the graphite particles along the sliding surface 13, resulting in improved seizure resistance. Furthermore, in the sliding member 10, the additive particles 16 contained in the sliding alloy portion 11 have a hardness of 200 HV to 500 HV. Therefore, the additive particles 16 contained in the sliding alloy portion 11 have low aggressiveness to the counter material with which the sliding member slides. As a result, the sliding member 10 of the present embodiment is less likely to damage the counter material, and exhibits less increase in friction, less adhesion to the counter member, and the like originating from the damage. Therefore, the mechanical properties and conformability can be ensured, and the seizure resistance as well as wear resistance can be improved, even under a high peripheral speed condition.

The present invention described above is not limited to the foregoing embodiments, and is applicable to various embodiments without departing from the scope of the present invention.

1. A sliding member, comprising:
a back metal portion; and
a sliding alloy portion provided on one surface of the back metal portion and having a sliding surface opposite to the back metal portion,
wherein the sliding alloy portion comprises:
a matrix consisting of a Cu-based alloy containing 5 to 15% by mass of Sn, with the remainder including an unavoidable impurity;
0.5 to 3% by mass of graphite particles; and
additive particles formed of 0.1 to 10% by mass of one selected from Co, Mo, Cr, and W, or an alloy thereof, and having a hardness of 200 HV to 500 HV,
wherein the graphite particles satisfy,
S1:S2=1:1.5 to 2.5,
wherein S1 represents an area of a first surface, which is a cross section in a thickness direction perpendicular to the sliding surface, and S2 represents an area of a second surface, which is a cross section parallel to the sliding surface perpendicular to the first surface.

2. The sliding member according to claim 1, wherein a content of the Sn in the sliding alloy portion is 12% by mass or less.

3. The sliding member according to claim 1, wherein a content of the graphite particles in the sliding alloy portion is 1 to 2% by mass.

4. The sliding member according to claim 1, wherein an area ratio of the graphite particles occupying the sliding surface is 2 to 20%.
